(19) United States
(12) Patent Application Publication
(10) Pub. No.: US 2025/0277116 A1
(43) Pub. Date: Sep. 4, 2025

(54) POLYMER-COATED IMIDACLOPRID COMPOSITE MICROSPHERE, PREPARATION METHOD AND APPLICATION THEREOF, AND CABLE

(71) Applicant: GUANGZHOU POWER SUPPLY BUREAU OF GUANGDONG POWER GRID CO., LTD., Guangzhou (CN)

(72) Inventors: Jiasheng HUANG, Guangzhou (CN); Zhuozhan HAN, Guangzhou (CN); Ying LING, Guangzhou (CN); Meng LI, Guangzhou (CN)

(73) Assignee: GUANGZHOU POWER SUPPLY BUREAU OF GUANGDONG POWER GRID CO., LTD., Guangzhou (CN)

(21) Appl. No.: 19/055,682

(22) Filed: Feb. 18, 2025

(30) Foreign Application Priority Data
Mar. 4, 2024 (CN) 202410244035.3

(51) Int. Cl. C09D 5/14; C09D 7/40; C09D 7/65; H01B 3/42

(52) U.S. Cl. CPC C09D 5/14; C09D 7/65; C09D 7/69; H01B 3/426

(57) ABSTRACT

The present disclosure provides a polymer-coated imidacloprid composite microsphere, a preparation method and an application thereof, and a cable. The polymer-coated imidacloprid composite microsphere includes a matrix and a polymer layer coated on a surface of the matrix. The matrix includes imidacloprid. The polymer has a heat deflection temperature of 70° C. to 200° C. The polymer is selected from a group consisting of polyethylene terephthalate, polycarbonate, polyphenylsulfone, and any combinations thereof.

### CROSS-REFERENCE TO RELATED APPLICATIONS

This application claims priority under 35 U.S.C. 119 from Chinese patent application No. 2024102440353, filed on Mar. 4, 2024, entitled “POLYMER-COATED IMIDACLOPRID COMPOSITE MICROSPHERE, PREPARATION METHOD AND APPLICATION THEREOF, AND CABLE”, the content of which are hereby incorporated herein in its entireties by reference.

### TECHNICAL FIELD

The present disclosure relates to the technical field of wire and cable protection, and specifically, to a polymer-coated imidacloprid composite microsphere, a preparation method and an application thereof, and a cable.

### BACKGROUND

Wires and cables are the primary carriers of power transmission and are widely used in various fields, including electrical devices, lighting systems, and household appliances. The environment in which wires and cables are installed can be quite complex. In dark and damp spaces, ants and insects are often present, and when they gnaw on the cables, the protective layers of the cables may be damaged. This damage allows moisture to infiltrate the wires and cables, leading to a reduction in insulation performance and potentially causing permanent damage to the cables.

Currently, insect repellents containing imidacloprid are directly added to wires and cables to mitigate the invasion of ants and insects. However, the processing temperature of the wires and cables is around 200° C., which is close to the thermal decomposition temperature of imidacloprid as the active ingredient at 268° C. As a result, during the production of the wires and cables, the decomposition and volatilization of imidacloprid occur, leading to a reduction in the concentration of imidacloprid within the wires and cables. This, in turn, adversely affects the insect-repellent properties of the cables.

### SUMMARY

A first aspect of the present disclosure provides a polymer-coated imidacloprid composite microsphere, including a matrix and a polymer layer coated on a surface of the matrix. The matrix includes imidacloprid. The polymer has a heat deflection temperature of 70° C. to 200° C. The polymer is selected from a group consisting of polyethylene terephthalate, polycarbonate, polyphenylsulfone, and any combinations thereof.

In one embodiment, a mass ratio of the matrix to the polymer layer is (0.1-2):(8-9.9).

In one embodiment, the polymer-coated imidacloprid composite microsphere has a particle size of 25 μm to 150 μm.

In one embodiment, the polymer-coated imidacloprid composite microsphere has a thermal decomposition temperature of greater than or equal to 450° C.

A second aspect of the present disclosure provides a method for preparing the polymer-coated imidacloprid composite microsphere according to any one of the embodiments of the first aspect of the present disclosure. The preparation method includes:
mixing a polymer and a matrix in an organic solvent to prepare a mixed liquid;
dissolving a surfactant in water to prepare a surfactant solution; and
mixing the mixed liquid with the surfactant solution, followed by emulsification, volatilization of the organic solvent, and filtration, to prepare the polymer-coated imidacloprid composite microsphere;
wherein the matrix includes imidacloprid, the polymer has a heat deflection temperature of 70° C. to 200° C., and the polymer is selected from a group consisting of polyethylene terephthalate, polycarbonate, polyphenylsulfone, and any combinations thereof.

In one embodiment, a mass-volume ratio of the polymer, the matrix, and the organic solvent is (8-9.9) g:(0.1-2) g:(45-55) mL.

In one embodiment, a mass-volume ratio of the surfactant to the water is (0.25-25) g:(100-300) mL.

In one embodiment, a mixed volume ratio of the mixed liquid to the surfactant solution is 1:(0.9-1.1).

In one embodiment, the emulsification is performed under stirring at a speed of 500 rpm to 3000 rpm and at a temperature of 10° C. to 80° C.

In one embodiment, a method of the volatilization of the organic solvent is selected from a group consisting of heating under stirring, rotary evaporation, and a combination thereof.

In one embodiment, the volatilization of the organic solvent is performed at a temperature of 10° C. to 80° C.

In one embodiment, the organic solvent is selected from a group consisting of tetrahydrofuran, dichloromethane, 1,2-dichloroethane, chloroform, acetone, 2-butanone, hexafluoroisopropanol, and any combinations thereof.

In one embodiment, the surfactant is selected from a group consisting of polyvinyl alcohol, Tween, polyvinyl pyrrolidone, and any combinations thereof.

A third aspect of the present disclosure provides an application of the polymer-coated imidacloprid composite microsphere according to any one of the embodiments of the first aspect of the present disclosure in an insect repellent and/or pesticide.

A fourth aspect of the present disclosure provides a cable, including a conductor and a cover layer sleeved on a surface of the conductor. The cover layer includes the polymer-coated imidacloprid composite microsphere according to any one of the embodiments of the first aspect of the present disclosure.

### BRIEF DESCRIPTION OF THE DRAWINGS

In order to illustrate the embodiments of the present application more clearly, the drawings used in the embodiments will be described briefly. It is evident that the following described figures are merely for some embodiments of the present application, and other figures can be derived by those of ordinary skill in the art without any creative effort.

FIG. 1 is a scanning electron microscope (SEM) diagram of a polymer-coated imidacloprid composite microsphere prepared in Example 1.

FIG. 2 is a diagram showing a particle size analysis on the polymer-coated imidacloprid composite microsphere prepared in Example 1.

FIG. 3 is a diagram showing thermogravimetric curves of the polymer-coated imidacloprid composite microsphere prepared in Example 1, a polymer microsphere prepared in Comparative Example 1, and imidacloprid of Comparative Example 2.

FIG. 4 is a diagram showing first-order derivative thermogravimetric curves of the polymer-coated imidacloprid composite microsphere prepared in Example 1, the polymer microsphere prepared in Comparative Example 1, and imidacloprid of Comparative Example 2.

FIG. 5 is a diagram showing FTIR spectra of the polymer-coated imidacloprid composite microsphere prepared in Example 1, the polymer microsphere prepared in Comparative Example 1, and imidacloprid of Comparative Example 2.

FIG. 6 is diagram showing ultraviolet absorption spectra of the polymer-coated imidacloprid composite microsphere prepared in Example 1, the polymer microsphere prepared in Comparative Example 1, and imidacloprid of Comparative Example 2.

### DETAILED DESCRIPTION

A polymer-coated imidacloprid composite microsphere and a preparation method and an application thereof, and a cable according to the present disclosure will be further completely and clearly described below with reference to specific embodiments. The present disclosure may be implemented in many different forms, and is not limited to the implementations described herein. Rather, the purpose of providing these implementations is to understand the contents of the present disclosure more thoroughly and completely.

The processing temperature of the wires and cables is around 200° C., which is close to the thermal decomposition temperature of imidacloprid at 268° C. As a result, during the production of the wires and cables, the decomposition and volatilization of imidacloprid occur, leading to a reduction in the concentration of active ingredient that prevents insects and ants within the wires and cables. Moreover, the wires and cables are often exposed to high-temperature working environments, which also leads to the decomposition and volatilization of imidacloprid. Consequently, the effective lifespan of insect and ant protection for the wires and cables is typically short.

In view of this, in a first aspect of the present disclosure, a polymer-coated imidacloprid composite microsphere is provided, including a matrix and a polymer layer coated on a surface of the matrix. The matrix includes imidacloprid. The polymer has a heat deflection temperature of 70° C. to 200° C. The polymer includes polyethylene terephthalate, polycarbonate, polyphenylsulfone, or combinations thereof.

The polymer-coated imidacloprid composite microsphere provided in the present disclosure includes the matrix and the polymer layer coated on a surface of the matrix, the matrix includes imidacloprid, and the polymer has a heat deflection temperature of 70° C. to 200° C. is selected to serve as an outer coating layer of imidacloprid. The specific polymer having high heat deflection temperature, such as polyethylene terephthalate, polycarbonate, and polyphenylsulfone, can insulate against heat transfer, which effectively prevents the volatilization and decomposition of the insect repellent containing imidacloprid under the processing conditions of wires and cables and enhances the stability and durability of imidacloprid in high-temperature environments, greatly improving the long-term ant resistance of the wires and cables.

Furthermore, the polymer-coated imidacloprid composite microsphere provided in the present disclosure also helps avoid health hazards and environmental pollution associated with the volatilization and decomposition of ant repellents during the production of the wires and cables and reduce the high cost caused by repeated application of ant repellents.

In an example, a mass ratio of the matrix to the polymer layer is (0.1-2):(8-9.9). By limiting the mass ratio of the matrix to the polymer layer, it ensures that the matrix is completely coated, and that the polymer-coated imidacloprid composite microsphere has a uniform and stable structure, thereby ensuring the durability and stability of insects and ants resistance of the wires and cables. It should be understood that the mass ratio of the matrix to the polymer layer can be selected from any numerical value within the range of (0.1-2):(8-9.9). Specifically, the mass ratio of the matrix to the polymer layer includes, but is not limited to, 0.1:9.9, 0.4:9, 0.5:9, 0.5:9.5, 0.5:9.9, 0.8:9.5, 1:9.5, 1.06:9.5, 1.1:9.5, 1.5:9.5, 1.6:9.5, 1.68:9.5, 1.7:9.5, 1.7:9.9, or 2:9.9.

In an example, the polymer-coated imidacloprid composite microsphere has a particle size of 25 μm to 150 μm. The polymer-coated imidacloprid composite microsphere having the particle size of 25 μm to 150 μm can provide sufficient surface area for contact and interaction with other components in the wires and cable and ensure good compatibility with other raw material components.

In an example, the polymer-coated imidacloprid composite microsphere has a thermal decomposition temperature of greater than or equal to 450° C. The thermal decomposition temperature of imidacloprid is conventionally 264° C., while the thermal decomposition temperature of the polymer-coated imidacloprid composite microsphere provided in the present disclosure is greater than or equal to 450° C., suggesting that the polymer-coated imidacloprid composite microsphere of the present disclosure has higher thermal stability and high temperature resistance. Specifically, the thermal decomposition temperature of the polymer-coated imidacloprid composite microsphere provided in the present disclosure is 450° C. to 500° C.

Preferably, the thermal decomposition temperature of the polymer-coated imidacloprid composite microsphere is 460° C. to 470° C.

In a second aspect of the present disclosure, a method for preparing the polymer-coated imidacloprid composite microsphere according to any one of the examples in the first aspect of the present disclosure is provided, including the following steps:
a), mixing a polymer and a matrix in an organic solvent to prepare a mixed liquid;
b), dissolving a surfactant in water to prepare a surfactant solution;
c), mixing the mixed liquid with the surfactant solution, followed by emulsification, volatilization of the organic solvent, and filtration, to prepare the polymer-coated imidacloprid composite microsphere.

In an example, in step a), a mass-volume ratio of the polymer, the matrix, and the organic solvent is (8-9.9) g:(0.1-2) g:(45-55) mL. By limiting the mass-volume ratio of the polymer, the matrix, and the organic solvent, not only the dissolution of the polymer and the matrix in the organic solvent can be ensured, but also the mass ratio of the matrix to the polymer layer in the prepared polymer-coated imidacloprid composite microsphere can be limited. Specifically, the mass-volume ratio of the polymer, the matrix, and the organic solvent includes, but is not limited to, 9 g:0.5 g:50 mL, 9.5 g:0.5 g:50 mL, 9.5 g:0.5 g:55 mL, 9.5 g:1 g:50 mL, 9.5 g:1.06 g:50 mL, 9.5 g:1.1 g:50 mL, 9.5 g:1.6 g:50 mL, 9.5 g:1.68 g:50 mL, 9.5 g:1.7 g:50 mL, or 9.5 g:2 g:55 mL.

In an example, in step b), a mass-volume ratio of the surfactant to the water is (0.25-25) g:(100-300) mL. Specifically, the mass-volume ratio of the surfactant to the water includes, but is not limited to, 0.25 g:100 mL, 1 g:200 mL, 1 g:240 mL, 1 g:250 mL, 1 g:260 mL, 1 g:280 mL, 1 g:300 mL, 5 g:100 mL, 5 g:200 mL, 5 g:240 mL, 5 g:250 mL, 5 g:260 mL, 5 g:280 mL, 5 g:300 mL, 10 g:100 mL, 10 g:200 mL, 10 g:240 mL, 10 g:250 mL, 10 g: 260 mL, 10 g:280 mL, or 10 g:300 mL.

In order to ensure the emulsification rate and the successful preparation of the polymer-coated imidacloprid composite microsphere, in an example, in step c), a volume ratio of the mixed liquid to the surfactant solution is 1:(0.9-1.1). Specifically, the volume ratio of the mixed liquid to the surfactant solution includes, but is not limited to, 1:0.9, 1:0.93, 1:0.95, 1:0.98, 1:1, 1:1.05, or 1:1.1.

In an example, in step c), the emulsification is performed at a stirring speed of 500 rpm to 3000 rpm and a temperature of 10° C. to 80° C. By adjusting the stirring speed and the emulsification temperature, the emulsification efficiency can be improved. Furthermore, the stirring speed of 500 rpm to 3000 rpm and the emulsification temperature of 10° C. to 80° C. can increase the shear force and collision force during the emulsification and promote the mixing and the dispersion of the liquid phase, thereby improving the emulsification efficiency and obtaining finer and more uniform polymer-coated imidacloprid particle. Specifically, the stirring speed includes, but is not limited to, 800 rpm, 1000 rpm, 1200 rpm, 1300 rpm, 1500 rpm, 2000 rpm, or 3000 rpm. The emulsification temperature includes, but is not limited to, 12° C., 15° C., 18° C., 20° C., 22° C., 28° C., 30° C., 32° C., 40° C., 50° C., 60° C., 70° C., or 80° C.

In an example, in step c), the method of the volatilization of the organic solvent includes heating under stirring, rotary evaporation, or a combination thereof.

In an example, in step c), the volatilization of the organic solvent is performed at a temperature of 10° C. to 80° C. It should be understood that, in the present disclosure, the temperature of the emulsification is consistent with the temperature of the volatilization of the organic solvent. Further, the volatilization of the organic solvent is performed at a rotate speed of 500 rpm to 3000 rpm, which can also be consistent with a rotate speed during the emulsification. The preparation method provided in the present disclosure is simple and can achieve the mass production of the polymer-coated imidacloprid composite microsphere.

In an example, the matrix includes imidacloprid. It should be understood that, in the present disclosure, the matrix can be imidacloprid or an insect and ant repellent with imidacloprid as the primary active ingredient.

In an example, the polymer includes polyethylene terephthalate, polycarbonate, polyphenylsulfone, or combinations thereof.

In order to improve the high-temperature resistance of the polymer-coated imidacloprid microsphere, it needs to ensure that a material of the polymer layer of the present disclosure has a high heat deflection temperature. Therefore, the heat deflection temperature of the material of the coating layer needs to be limited. That is, the polymer selected in the present disclosure is a high-temperature resistant resin, but not a biocompatible resin. In an example, the heat deflection temperature of the polymer is 70° C. to 200° C. It should be understood that, the heat deflection temperature of the polymer can be selected from any numerical value between 70° C. and 200° C. Specifically, the heat deflection temperature includes, but is not limited to, 70° C., 80° C., 90° C., 100° C., 110° C., 120° C., 130° C., 140° C., 150° C., 160° C., 162° C., 164° C., 165° C., 166° C., 168° C., 170° C., 172° C., 174° C., 175° C., 176° C., 177° C., 178° C., 180° C., 182° C., 185° C., 188° C., 190° C., or 200° C. For example, the heat deflection temperature of the polymer is 160° C. to 200° C.

In an example, the polycarbonate exhibits a melt index of 8 g/10 min to 15 g/10 min when measured at 330° C. under a load of 2.16 kg. Specifically, the melt index of the polycarbonate when measured at 330° C. under a load of 2.16 kg includes, but is not limited to, 8.5 g/10 min, 9 g/10 min, 9.5 g/10 min, 10 g/10 min, 10.5 g/10 min, 11 g/10 min, 12 g/10 min, 12.5 g/10 min, 13 g/10 min, 13.5 g/10 min, 14 g/10 min, 14.5 g/10 min, or 15 g/10 min.

In an example, the organic solvent includes tetrahydrofuran, dichloromethane, 1,2-dichloroethane, chloroform, acetone, 2-butanone, hexafluoroisopropanol, or combinations thereof.

In an example, the surfactant includes polyvinyl alcohol, Tween, polyvinyl pyrrolidone, or combinations thereof. Specifically, the surfactant includes, but is not limited to, polyvinyl alcohol 588, polyvinyl alcohol 1788, and polyvinyl alcohol 1799, or combinations thereof.

In an example, in step c), the method further includes steps of washing and drying after the volatilization of the organic solvent and the filtration. Optionally, the washing is performed with a solvent at a temperature of 60° C. to 100° C.

In a specific example, the method for preparing the polymer-coated imidacloprid composite microsphere includes the following steps:

S100, mixing the polymer, the matrix, and the organic solvent at a mass-volume ratio of (8-9.9) g:(0.1-2) g:(45-55) mL to prepare the mixed liquid, wherein the matrix includes imidacloprid, and the polymer has a heat deflection temperature of 70° C. to 200° C.;

S200, mixing the surfactant with the water at a mass-volume ratio of (0.25-25) g:(100-300) mL to prepare the surfactant solution;

S300, mixing the mixed liquid with the surfactant solution at a volume ratio of 1:(0.9-1.1), followed by emulsification and volatilization of the organic solvent at a stirring speed of 500 rpm to 3000 rpm and a temperature of 10° C. to 80° C., filtration, washing with a solvent at a temperature of 60° C. to 100° C., and drying, to prepare the polymer-coated imidacloprid composite microsphere.

In a third aspect of the present disclosure, an application of the polymer-coated imidacloprid composite microsphere according to any one of the examples in the first aspect of the present disclosure in an insect repellent and/or a pesticide is provided.

In a fourth aspect of the present disclosure, a cable is provided, including a conductor and a cover layer sleeved on a surface of the conductor. The cover layer includes the polymer-coated imidacloprid composite microsphere according to any one of the examples in the first aspect of the present disclosure.

The present disclosure is further described in detail below with reference to specific examples. It should be understood that the following examples are only used to further illustrate the present disclosure and are not to be construed as limitations on the scope of protection of the present disclosure, and some non-essential improvements and adjustments made by those skilled in the art in accordance with the foregoing contents of the present disclosure are within the scope of protection of the present disclosure. The specific process parameters and the like of the following examples are also only an example of a suitable range, that is, those skilled in the art may select within a suitable range through the description herein, and is not necessarily limited to the specific numerical values of the following examples.

### [Raw Material]

Imidacloprid: purchased from Hubei Huiheyuan Co., Ltd, with a purity of 97% and a melting point of about 140° C.

Polycarbonate: with a model of Bayer PC1895, a heat deflection temperature of 174° C., and a melt index of 10 g/10 min when measured at 330° C. under a load of 2.16 kg.

Polyvinyl alcohol 1788: purchased from Aladdin reagent.

### Example 1

In Example 1 of the present disclosure, a polymer-coated imidacloprid composite microsphere was provided by a preparation method including the following steps.
(1) 0.5 g of imidacloprid and 9.5 g of polycarbonate were added to 50 mL of dichloromethane and stirred magnetically at a rotate speed of 600 rpm for 2 h to prepare a mixed liquid.
(2) 1 g of polyvinyl alcohol 1788 was added to 250 mL of deionized water and stirred at a speed of 800 rpm and a temperature of 90° C. until being completely dissolved to prepare a surfactant solution which was then cooled to room temperature for later use.
(3) The mixed liquid prepared in step (1) was poured into the cooled surfactant solution in step (2), stirred at a speed of 1500 rpm and a temperature of 10° C. to achieve full emulsification, and then continuously stirred at the speed of 1500 rpm and the temperature of 10° C. until the dichloromethane was completely volatilized. Then the mixed liquid was passed sequentially through 100-mesh and 500-mesh nylon filter bags and washed for 5 times with 60° C. hot water. The solids in the 500-mesh nylon filter bag were collected and then dried in an oven at 70° C. for 12 h to obtain the polymer-coated imidacloprid composite microsphere.

### Example 2

Example 2 of the present disclosure was substantially the same as Example 1, except that the mass of the imidacloprid in step (1) in Example 2 was 1.06 g. Specifically, the preparation method included the following steps.
(1) 1.06 g of imidacloprid and 9.5 g of polycarbonate were added to 50 mL of dichloromethane and stirred magnetically at a rotate speed of 600 rpm for 2 h to prepare a mixed liquid.
(2) 1 g of polyvinyl alcohol 1788 was added to 250 mL of deionized water and stirred at a speed of 800 rpm and a temperature of 90° C. until being completely dissolved to prepare a surfactant solution which was then cooled to room temperature for later use.
(3) The mixed liquid prepared in step (1) was poured into the cooled surfactant solution in step (2), stirred at a speed of 1500 rpm and a temperature of 10° C. to achieve full emulsification, and then continuously stirred at the speed of 1500 rpm and the temperature of 10° C. until the dichloromethane was completely volatilized. Then the mixed liquid was passed sequentially through 100-mesh and 500-mesh nylon filter bags and washed for 5 times with 60° C. hot water. The solids in the 500-mesh nylon filter bag were collected and then dried in an oven at 70° C. for 12 h to obtain the polymer-coated imidacloprid composite microsphere.

### Example 3

Example 3 of the present disclosure was substantially the same as Example 1, except that the mass of the imidacloprid in step (1) in Example 3 was 1.68 g. Specifically, the preparation method included the following steps.
(1) 1.68 g of imidacloprid and 9.5 g of polycarbonate were added to 50 mL of dichloromethane and stirred magnetically at a rotate speed of 600 rpm for 2 h to prepare a mixed liquid.
(2) 1 g of polyvinyl alcohol 1788 was added to 250 mL of deionized water and stirred at a speed of 800 rpm and a temperature of 90° C. until being completely dissolved to prepare a surfactant solution which was then cooled to room temperature for later use.
(3) The mixed liquid prepared in step (1) was poured into the cooled surfactant solution in step (2), stirred at a speed of 1500 rpm and a temperature of 10° C. to achieve full emulsification, and then continuously stirred at the speed of 1500 rpm and the temperature of 10° C. until the dichloromethane was completely volatilized. Then the mixed liquid was passed sequentially through 100-mesh and 500-mesh nylon filter bags and washed for 5 times with 60° C. hot water. The solids in the 500-mesh nylon filter bag were collected and then dried in an oven at 70° C. for 12 h to obtain the polymer-coated imidacloprid composite microsphere.

### Example 4

Example 4 of the present disclosure was substantially the same as Example 2, except that the temperature of the emulsification and the volatilization of dichloromethane was 20° C. in step (3) in Example 4. Specifically, the preparation method included the following steps.
(1) 1.06 g of imidacloprid and 9.5 g of polycarbonate were added to 50 mL of dichloromethane and stirred magnetically at a rotate speed of 600 rpm for 2 h to prepare a mixed liquid.
(2) 1 g of polyvinyl alcohol 1788 was added to 250 mL of deionized water and stirred at a speed of 800 rpm and a temperature of 90° C. until being completely dissolved to prepare a surfactant solution which was then cooled to room temperature for later use.
(3) The mixed liquid prepared in step (1) was poured into the cooled surfactant solution in step (2), stirred at a speed of 1500 rpm and a temperature of 20° C. to achieve full emulsification, and then continuously stirred at the speed of 1500 rpm and the temperature of 20° C. until the dichloromethane was completely volatilized. Then the mixed liquid was passed sequentially through 100-mesh and 500-mesh nylon filter bags and washed for 5 times with 60° C. hot water. The solids in the 500-mesh nylon filter bag were collected and then dried in an oven at 70° C. for 12 h to obtain the polymer-coated imidacloprid composite microsphere.

### Example 5

Example 5 of the present disclosure was substantially the same as Example 2, except that the temperature of the emulsification and the volatilization of dichloromethane was 30° C. in step (3) in Example 5. Specifically, the preparation method included the following steps.
(1) 1.06 g of imidacloprid and 9.5 g of polycarbonate were added to 50 mL of dichloromethane and stirred magnetically at a rotate speed of 600 rpm for 2 h to prepare a mixed liquid.
(2) 1 g of polyvinyl alcohol 1788 was added to 250 mL of deionized water and stirred at a speed of 800 rpm and a temperature of 90° C. until being completely dissolved to prepare a surfactant solution which was then cooled to room temperature for later use.
(3) The mixed liquid prepared in step (1) was poured into the cooled surfactant solution in step (2), stirred at a speed of 1500 rpm and a temperature of 30° C. to achieve full emulsification, and then continuously stirred at the speed of 1500 rpm and the temperature of 30° C. until the dichloromethane was completely volatilized. Then the mixed liquid was passed sequentially through 100-mesh and 500-mesh nylon filter bags and washed for 5 times with 60° C. hot water. The solids in the 500-mesh nylon filter bag were collected and then dried in an oven at 70° C. for 12 h to obtain the polymer-coated imidacloprid composite microsphere.

### Comparative Example 1

Comparative Example 1 of the present disclosure was substantially the same as Example 1, except that no imidacloprid was added in step (1) in Comparative Example 1. Specifically, the preparation method included the following steps.
(1) 9.5 g of polycarbonate was added to 50 mL of dichloromethane and stirred magnetically at a rotate speed of 600 rpm for 2 h to prepare a mixed liquid.
(2) 1 g of polyvinyl alcohol 1788 was added to 250 mL of deionized water and stirred at a speed of 800 rpm and a temperature of 90° C. until being completely dissolved to prepare a surfactant solution which was then cooled to room temperature for later use.
(3) The mixed liquid prepared in step (1) was poured into the cooled surfactant solution in step (2), stirred at a speed of 1500 rpm and a temperature of 10° C. to achieve full emulsification, and then continuously stirred at the speed of 1500 rpm and the temperature of 10° C. until the dichloromethane was completely volatilized. Then the mixed liquid was passed sequentially through 100-mesh and 500-mesh nylon filter bags and washed for 5 times with 60° C. hot water. The solids in the 500-mesh nylon filter bag were collected and then dried in an oven at 70° C. for 12 h to obtain a polymer microsphere.

### Comparative Example 2

Imidacloprid, which was raw material in previous Examples, was used as Comparative Example 2.

The polymer-coated imidacloprid composite microspheres prepared in Examples 1 to 5, the polymer microsphere prepared in Comparative Example 1, and imidacloprid in Comparative Example 2 were tested as follows.

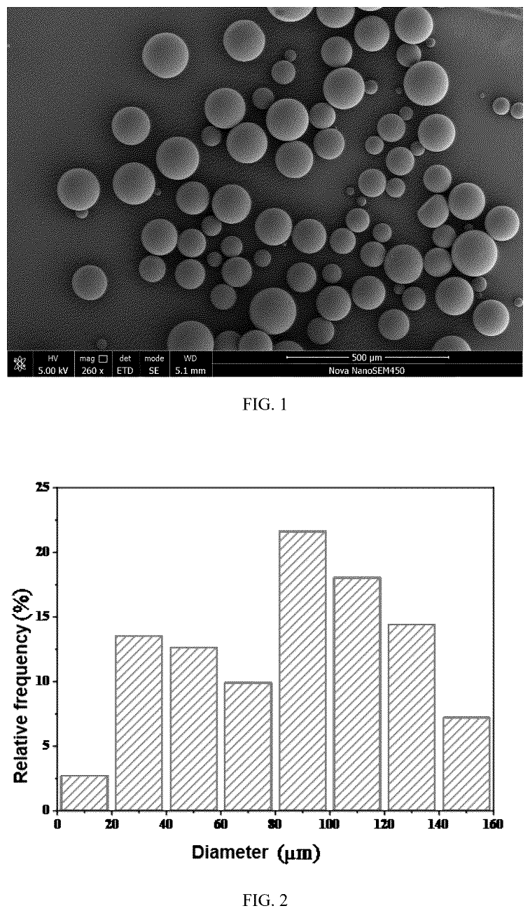

Microscopic morphology: The surface morphology and particle size distribution of the polymer-coated imidacloprid composite microsphere prepared in Example 1 were analyzed by scanning electron microscope (SEM, NovaNanoSEM450, FEI, USA) at an acceleration voltage of 5.0 kV and the characterization results were shown in FIG. 1 and FIG. 2.

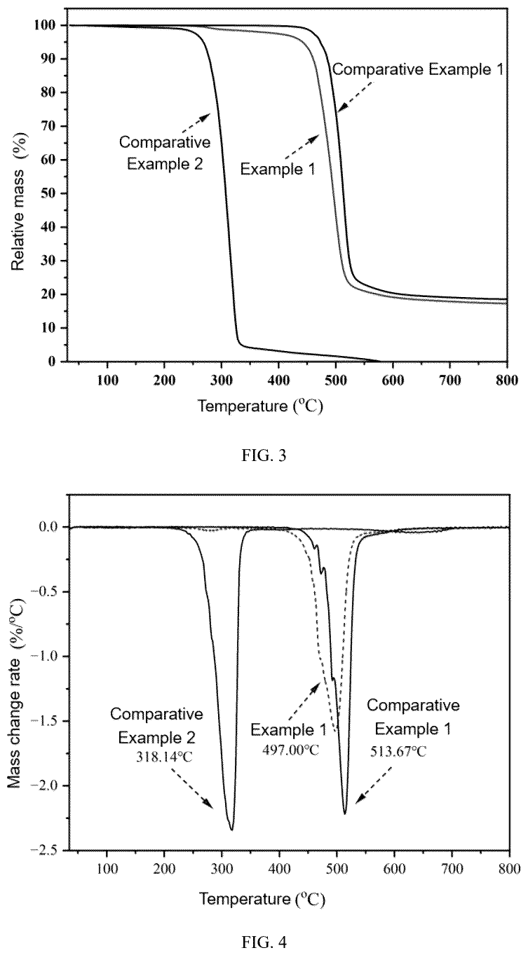

Thermal stability: The thermogravimetric curves of the polymer microsphere in Comparative Example 1, the imidacloprid in Comparative Example 2, and the polymer-coated imidacloprid composite microspheres in Examples 1 to 5 were tested and the experimental results were shown in FIG. 3, FIG. 4, Table 1, and Table 2.

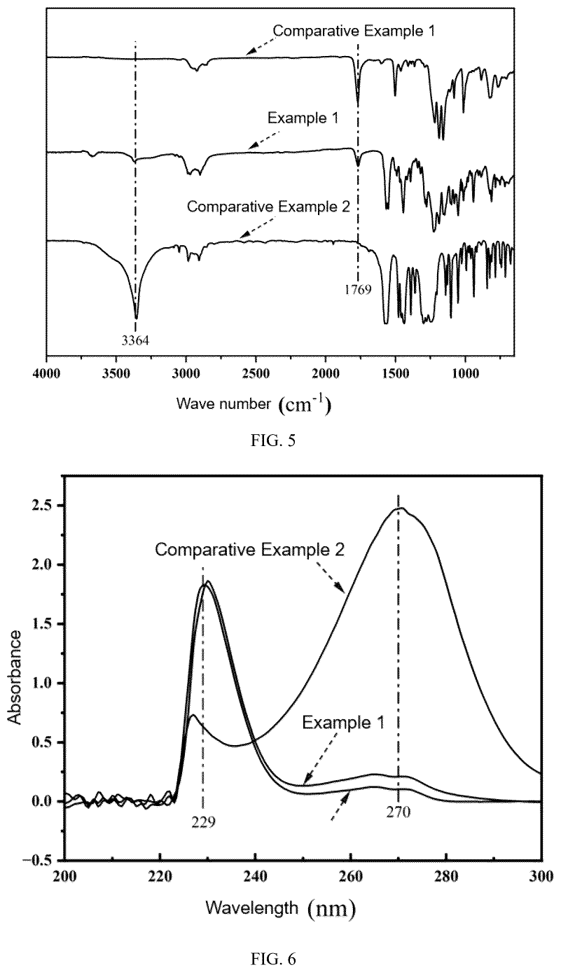

Qualitative characterization: The polymer-coated imidacloprid composite microsphere prepared in Example 1 was analyzed by fourier transform infrared spectrometer (FTIR, Nicolet6700, TFS, USA) at 4000-650 cm⁻¹ and test results were shown in FIG. 5.

Quantitative characterization: The polymer-coated imidacloprid composite microsphere prepared in Example 1, the polymer microsphere prepared in Comparative Example 1, and the imidacloprid active compound in Comparative Example 2 were each dissolved in dichloromethane to prepare a solution with a mass concentration of 0.04 g/L. The resulting solutions were tested with absorbance at a wavelength of 200-300 nm by ultraviolet-visible spectrophotometer (UV-Vis, Lambda750s, PKI, USA) to determine the content of imidacloprid in the polymer-coated imidacloprid composite microsphere in Example 1. The obtained spectrum was shown in FIG. 6.

TABLE 1
Thermal decomposition temperatures of Examples
1 to 5 and Comparative examples 1 to 2

| | Temperature of initial | Temperature of maximum |
|---|---|---|
| | decomposition (° C.) | decomposition (° C.) |
| Example 1 | 460.55 | 497.00 |
| Example 2 | 466.17 | 505.67 |
| Example 3 | 465.57 | 500.17 |
| Example 4 | 466.47 | 511.99 |
| Example 5 | 466.62 | 512.98 |
| Comparative | 479.61 | 513.67 |
| Example 1 | | |
| Comparative | 268.10 | 318.14 |
| Example 2 | | |

TABLE 2
Thermal stabilities of Examples 1 to 5 and Comparative examples 1 to 2

| | Example | Example | Example | Example | Example | Comparative | Comparative |
|---|---|---|---|---|---|---|---|
| | 1 | 2 | 3 | 4 | 5 | Example 1 | Example 2 |
| Temperature | 460.17 | 468.67 | 467.17 | 468.10 | 468.26 | 485.00 | 278.10 |
| corresponding to | | | | | | | |
| 10% mass loss | | | | | | | |
| (° C.) | | | | | | | |
| Temperature | 481.50 | 490.83 | 486.00 | 493.57 | 498.60 | 502.67 | 296.16 |
| corresponding to | | | | | | | |
| 30% mass loss | | | | | | | |
| (° C.) | | | | | | | |
| Temperature | 495.67 | 503.33 | 498.83 | 507.98 | 510.84 | 513.00 | 306.17 |
| corresponding to | | | | | | | |
| 50% mass loss | | | | | | | |
| (° C.) | | | | | | | |
| Temperature | 510.00 | 515.00 | 511.83 | 521.37 | 522.96 | 523.83 | 314.13 |
| corresponding to | | | | | | | |
| 70% mass loss | | | | | | | |
| (° C.) | | | | | | | |

As shown in FIG. 1, the polymer-coated imidacloprid composite microsphere prepared according to the present disclosure has a smooth surface and a regular shape. As shown in FIG. 2, the majority (97.3%) of the microspheres has a particle size of 25 μm to 150 μm.

Through analysis of FIG. 3, FIG. 4, and Table 1, it was found that the active compound imidacloprid in Comparative Example 2 exhibited decomposition behavior at 268.1° C., with the maximum decomposition rate occurring at 318.1° C. In contrast, the polymer-coated imidacloprid composite microsphere prepared in Example 1 exhibited decomposition behavior at 460.6° C., with the maximum decomposition rate occurring at 497.0° C. The thermal stabilities of the polymer-coated imidacloprid composite microspheres prepared in Example 2 to 5 were analyzed similarly. The results showed that the temperatures of initial decomposition and maximum decomposition of these polymer-coated imidacloprid composite microspheres were close to those of the polymer microsphere in Comparative Example 1, demonstrating that the polymer-coated imidacloprid composite microsphere provided according to the present disclosure has improved thermal stability.

The temperatures at which the polymer-coated imidacloprid composite microspheres in Examples 1-5, the polymer microsphere in Comparative Example 1, and the imidacloprid in Comparative Example 2 experienced the same mass loss were recorded in Table 2. The results showed that the temperatures corresponding to 10%, 30%, 50%, and 70% mass losses for the polymer-coated imidacloprid composite microspheres in Examples 1-5 were all higher than those for Comparative Example 2, and were close to the temperature at which the polymer microsphere in Comparative Example 1 reached the same mass loss. This further supports the conclusion that the polymer-coated imidacloprid composite microsphere provided according to the present disclosure has improved thermal stability.

The absorption peaks observed at 3364 cm⁻¹ and 1769 cm⁻¹ in FIG. 5 correspond to the stretching vibrations of the secondary amine N—H bond in imidacloprid and the carbonyl group in the polycarbonate molecule, respectively, suggesting that the polymer-coated imidacloprid composite microsphere has been successfully prepared.

Based on the principle of absorbance additivity, the total absorbance of the polymer-coated imidacloprid composite microsphere solution is equal to the sum of the absorbances of its two components: the polymer and imidacloprid. Wavelengths of 229 nm and 270 nm in FIG. 6 were selected to maximize the difference in absorbance between the two components. The absorbances of the polymer-coated imidacloprid composite microsphere solution at these two wavelengths were measured, and the formulation of a system of linear equations in two variables was obtained based on the absorbance additivity. The concentration cₓ of imidacloprid can be determined through simultaneous equations. The drug-loading rate and the encapsulation efficiency of the polymer-coated imidacloprid composite microsphere can then be calculated by further comparing these values with the theoretical addition amount of imidacloprid. The calculations revealed that the drug-loading rate of the polymer-coated imidacloprid composite microsphere prepared in Example 1 was 4.5%, with the encapsulation efficiency of 90%.

$$\{ \begin{matrix}{A}_{229 nm} = {a}_{{x}_{1}} b {c}_{x} + {a}_{{y}_{1}} b {c}_{y} \\ {A}_{270 nm} = {a}_{{x}_{2}} b {c}_{x} + {a}_{{y}_{2}} b {c}_{y}\end{matrix}$$

wherein, aₓ_{₁} represents the absorption coefficient of imidacloprid at 229 nm, aₓ_{₂} represents the absorption coefficient of imidacloprid at 270 nm, a_{y}_{₁} represents the absorption coefficient of the polymer at 229 nm, a_{y}_{₂} represents the absorption coefficient of the polymer at 270 nm, b represents the optical path length, cₓ represents the concentration of imidacloprid, c_{y} represents the concentration of the polymer, and aₓ_{₁}, aₓ_{₂}, a_{y}_{₁}, and a_{y}_{₂} can be previously measured using the same method on solutions of respective components in Comparative Examples 1 and 2 with known concentrations.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the patent protection of the present application shall be defined by the appended claims.

What is claimed is:

1. A polymer-coated imidacloprid composite microsphere, comprising a matrix and a polymer layer coated on a surface of the matrix, wherein the matrix comprises imidacloprid, the polymer has a heat deflection temperature of 70° C. to 200° C., and the polymer is selected from a group consisting of polyethylene terephthalate, polycarbonate, polyphenylsulfone, and any combinations thereof.

2. The polymer-coated imidacloprid composite microsphere according to claim 1, wherein a mass ratio of the matrix to the polymer layer is (0.1-2):(8-9.9).

3. The polymer-coated imidacloprid composite microsphere according to claim 1, wherein the polymer-coated imidacloprid composite microsphere has a particle size of 25 μm to 150 μm.

4. The polymer-coated imidacloprid composite microsphere according to claim 1, wherein the polymer-coated imidacloprid composite microsphere has a thermal decomposition temperature of greater than or equal to 450° C.

5. The polymer-coated imidacloprid composite microsphere according to claim 1, wherein the matrix is encapsulated by the polymer layer.

6. A method for preparing the polymer-coated imidacloprid composite microsphere of claim 1, comprising:
mixing a polymer and a matrix in an organic solvent to prepare a mixed liquid;
dissolving a surfactant in water to prepare a surfactant solution; and
mixing the mixed liquid with the surfactant solution, followed by emulsification, volatilization of the organic solvent, and filtration, to prepare the polymer-coated imidacloprid composite microsphere;
wherein the matrix comprises imidacloprid, the polymer has a heat deflection temperature of 70° C. to 200° C., and the polymer is selected from a group consisting of polyethylene terephthalate, polycarbonate, polyphenylsulfone, and any combinations thereof.

7. The method according to claim 6, wherein a mass-volume ratio of the polymer, the matrix, and the organic solvent is (8-9.9) g:(0.1-2) g:(45-55) mL.

8. The method according to claim 6, wherein a mass-volume ratio of the surfactant to the water is (0.25-25) g:(100-300) mL.

9. The method according to claim 6, wherein a volume ratio of the mixed liquid to the surfactant solution is 1:(0.9-1.1).

10. The method according to claim 6, wherein the emulsification is performed under stirring at a speed of 500 rpm to 3000 rpm and at a temperature of 10° C. to 80° C.

11. The method according to claim 6, wherein a method of the volatilization of the organic solvent is selected from a group consisting of heating under stirring, rotary evaporation, and a combination thereof.

12. The method according to claim 6, wherein the volatilization of the organic solvent is performed at a temperature of 10° C. to 80° C.

13. The method according to claim 6, wherein the organic solvent is selected from a group consisting of tetrahydrofuran, dichloromethane, 1,2-dichloroethane, chloroform, acetone, 2-butanone, hexafluoroisopropanol, and any combinations thereof.

14. The method according to claim 6, wherein the surfactant is selected from a group consisting of polyvinyl alcohol, Tween, polyvinyl pyrrolidone, and any combinations thereof.

15. An application of the polymer-coated imidacloprid composite microsphere of claim 1 in an insect repellent and/or pesticide, comprising preparing the insect repellent and/or pesticide from the polymer-coated imidacloprid composite microsphere or using the polymer-coated imidacloprid composite microsphere as the insect repellent and/or pesticide.

16. A cable, comprising a conductor and a cover layer sleeved on a surface of the conductor, wherein the cover layer comprises the polymer-coated imidacloprid composite microsphere of claim 1.
